(19) United States
(12) Patent Application Publication
(10) Pub. No.: US 2011/0268365 A1
(43) Pub. Date: Nov. 3, 2011

(54) 3D HAND POSTURE RECOGNITION SYSTEM AND VISION BASED HAND POSTURE RECOGNITION METHOD THEREOF

(75) Inventors: CHUNG-CHENG LOU, TAIPEI (TW); JING-WEI WANG, LOS ANGELES, CA (US)

(73) Assignee: ACER INCORPORATED, Taipei County (TW)

(21) Appl. No.: 12/770,731

(22) Filed: Apr. 30, 2010

(51) Int. Cl. G06K 9/62

(52) U.S. Cl. 382/224

(57) ABSTRACT

A vision based hand posture recognition method and system thereof are disclosed. The method comprises the following steps of receiving an image frame; extracting a contoured hand image from said image frame; calculating a gravity center of said contoured hand image; obtaining contour points on a contour of said contoured hand image; calculating distances between said gravity center and said multiple contour points; recognizing a hand posture according to a first characteristic function of said multiple contour points. In embodiment, the finger number and hand direction of the hand posture can be determined according to the number and location of at least one peak of the first characteristic function.

### TECHNICAL FIELD

The present invention relates generally to hand posture recognition system, more particularly, related to a vision based hand posture recognition system having lower complexity.

### BACKGROUND

Friendly interaction between human and computer is critical for the development of entertainment systems, especially for gaming systems. The rapid development of the motion analyses systems and computer-controlled devices has introduced possibility of new ways of interacting with computers. However, many existing solutions make use of sensor devices which often needed to be attached on the user fingers. Although this way can offer accurate hand detection, it also increases users' burden. One preferred method is to use hand as a commanding device, i.e. using movements to enter commands into the operating system of the computer or control peripheral devices. However, the known methods and systems are rather complex and not robust enough.

According to U.S. Pat. No. 6,002,808, a system is provided for rapidly recognizing hand gestures for the control of computer graphics, in which image moment calculations are utilized to determine an overall equivalent rectangle corresponding to hand position, orientation and size, with size in one embodiment correlating to the width of the hand. In a further embodiment, a hole generated through the utilization of the touching of the forefinger with the thumb provides a special trigger gesture recognized through the corresponding hole in the binary representation of the hand. In a further embodiment, image moments of images of other objects are detected for controlling or directing onscreen images.

According to U.S. Pat. No. 7,129,927, a gesture recognition system including elements for detecting and generating a signal corresponding to a number of markers arranged on an object, elements for processing the signal from the detecting elements, members for detecting position of the markers in the signal. The markers are divided into first and second set of markers, the first set of markers constituting a reference position and the system comprises elements for detecting movement of the second set of markers and generating a signal as a valid movement with respect to the reference position.

There thus is a need for a interaction system that offers an unconstrained or natural way for users to interact with computer, which means users can control without any other devices but their own hands.

### SUMMARY OF THE INVENTION

Therefore, an object of the present invention is to provide a 3D hand posture recognition system, vision based hand recognition method and system thereof, so as to reduce computing complexity of vision based recognition and achieve real-time performance.

The object of the present invention can be achieved by providing a vision based hand posture recognition method, and the method comprises the following steps of receiving an image frame; extracting a contoured hand image from the image frame; calculating a gravity center of the contoured hand image; obtaining contour points on a contour of the contoured hand image; calculating distances between the gravity center and the multiple contour points; and recognizing a hand posture according to a first characteristic function of the multiple distances.

Preferably, the step of recognizing a hand posture further comprises steps of setting a reference point; calculating a first line between the gravity center and the reference point; calculating second lines between the gravity center and each of the contour points; calculating angles between the first line and the second lines; and defining the first characteristic function being a function of the angles and the distances.

Preferably, the step of recognizing a hand posture further comprises steps of providing a database recording second characteristic functions of multiple predefined hand postures; calculating cost values between the first characteristic function and the second characteristic functions; and selecting one of multiple predefined hand postures as the hand posture according to the cost values.

Preferably, the step of recognizing a hand posture further comprises steps of determining whether any peak exists in the first characteristic function; and recognizing the hand posture according to number and location of the peak of the first characteristic function if at least one peak exists in the first characteristic function.

Preferably, the hand posture is determined to be a fist posture if no peak exists in the first characteristic function.

Preferably, a finger number of the hand posture is determined according to the number of the peak.

Preferably, a hand direction of the hand posture is determined according to the location of the peak.

The object of the present invention can be achieved by providing a vision based hand posture recognition system. The system comprises an image capture unit, an image processing unit, a data processing unit and a hand posture recognition unit. The image capture unit is operable to receive an image frame, and image processing unit then extracts a contoured hand image from the image frame and calculating a gravity center of the contoured hand image. The data processing unit is operable to obtain contour points on a contour of the contoured hand image, and calculating distances between the gravity center and the multiple contour points. The hand posture recognition unit is operable to recognize a hand posture according to a first characteristic function of the multiple distances.

Preferably, the data processing unit further calculates angles between a first line and multiple second lines, and defines the first characteristic function being a function of the angles and the distances, wherein the first line is connected with the gravity center and a reference point, and each of the second lines is connected with the gravity center and each of the contour points.

Preferably, the system further comprises a database recording second characteristic functions of multiple predefined hand postures, and the hand posture recognition unit further calculates cost values between the first characteristic function and the second characteristic functions, and selects one of multiple predefined hand postures as the hand posture according to the cost values.

Preferably, the hand posture recognition unit determines at least one peak of the first characteristic function, and recognizes the hand posture according to number and location of the peak of first characteristic function.

Preferably, the hand posture recognition unit determines the hand posture to be a fist posture if no peak exists in the first characteristic function.

Preferably, the hand posture recognition unit determines a finger number of the hand posture according to the number of the peak, and determines a hand direction of the hand posture according to the location of the peak.

The object of the present invention can be achieved by providing a 3D hand posture recognition system. The system comprises a first image capture unit, a second image capture unit, an image processing unit, a data processing unit and a hand posture recognition unit. The first image capture unit receives a first image frame and the second image capture unit receives a second image frame. The image processing unit is operable to extract a first contoured hand image and a second contoured hand image from the first image frame and the second image frame respectively, and calculate a first gravity center of the first contoured hand image and a second gravity center of the second contoured hand image. The data processing unit then obtains first contour points on the contour of the first contoured hand image, and obtains second contour points on the contour of the second contoured hand image, and calculates first distances between the first gravity center and the first multiple contour points, and calculates second distances between the second gravity center and the second multiple contour points. The hand posture recognition unit is operable to recognize a first hand posture according to a first characteristic function of the multiple first distances, and recognize a second hand posture according to a second characteristic function of the multiple second distances, and determine a 3D hand posture according to the first hand posture and the second hand posture.

Preferably, the hand posture recognition unit recognizes the first hand posture according to number and location of at least one peak of the first characteristic function, and recognizes the second hand posture according to number and location of at least one peak of the second characteristic function.

### BRIEF DESCRIPTION OF THE DRAWINGS

The accompanying drawings, which are included to provide a further understanding of the invention, illustrate embodiments of the invention and together with the description serve to explain the principle of the invention.

FIG. 1 illustrates a flow chart of embodiment of a vision based hand posture recognition method in accordance with the present invention;

FIG. 2 illustrates schematic view of hand image in accordance with the present invention;

FIG. 3 illustrates schematic view of contoured hand image in accordance with the present invention;

FIG. 4 illustrates first exemplary waveform chart of the characteristic function of the distances and included angles corresponding to contour points in accordance with the present invention;

FIG. 5 illustrates second exemplary waveform chart of the characteristic function of the distances and included angles corresponding to contour points in accordance with the present invention;

FIG. 6 illustrates third exemplary waveform chart of the characteristic function of the distances and included angles corresponding to contour points in accordance with the present invention;

FIG. 7 illustrates a block diagram of embodiment of a vision based hand posture recognition system in accordance with the present invention; and

FIG. 8 illustrates a block diagram of embodiment of a 3D hand posture recognition system in accordance with the present invention.

### DETAILED DESCRIPTION OF THE PREFERRED EMBODIMENTS

In the following detailed description, reference is made to the accompanying drawing figures which form a part hereof, and which show by way of illustration specific embodiments of the invention. It is to be understood by those of ordinary skill in this technological field that other embodiments may be utilized, and structural, electrical, as well as procedural changes may be made without departing from the scope of the present invention. Wherever possible, the same reference numbers will be used throughout the drawings to refer to the same or similar parts.

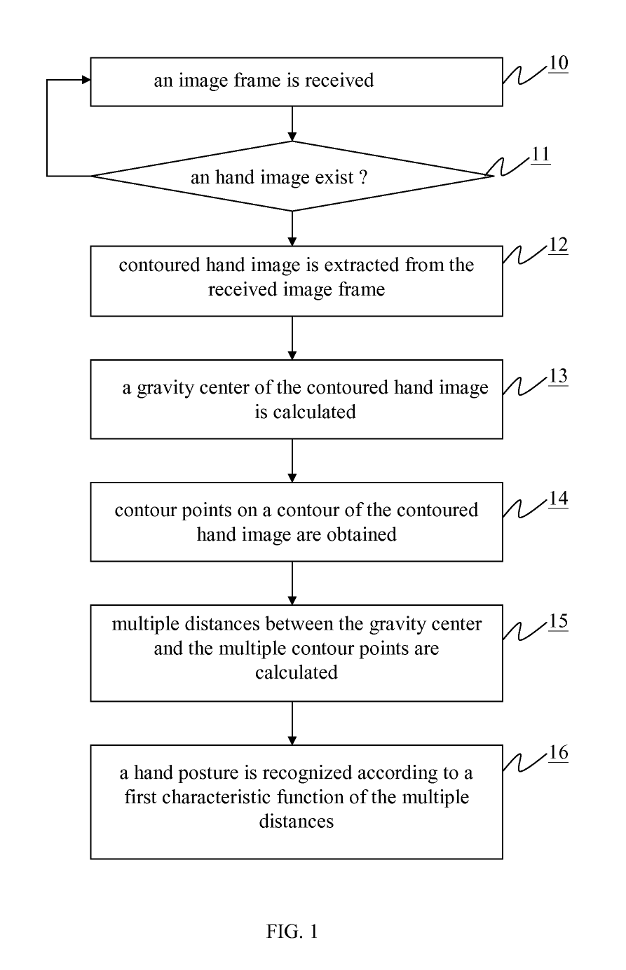

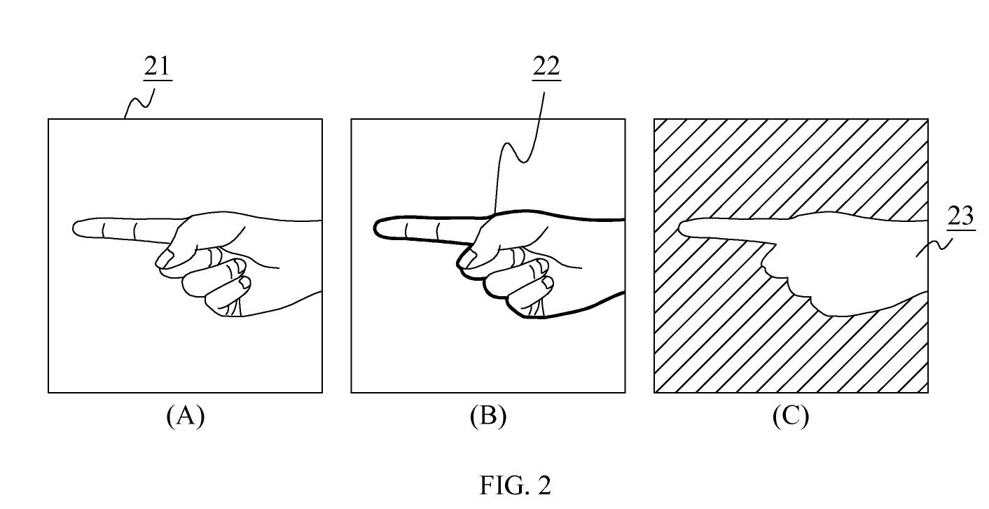

FIG. 1 illustrates a flow chart of embodiment of a vision based hand posture recognition method in accordance with the present invention. This embodiment comprises the following steps. In step 10 an image frame is received, and then it is determined whether a hand image exists in the received image frame in step 11. If no hand image exists in the received image frame, then step 10 is repeated; otherwise, if a hand image exists in the received image frame, such as hand image 21 shown in FIG. 2, a contoured hand image is extracted from the received image frame in step 12. Preferably, an edge detection can be performed for the hand image 21, to extract a hand contour, such as the hand contour 22 shown in FIG. 2, so that the image area 23 surrounded by the hand contour 32 and the edge of the hand image 236 can be defined as the contoured hand image.

In step 13 a gravity center of the contoured hand image is calculated. Preferably, a palm orientation calculation can be performed to obtain a gravity center of the contoured hand image 237. For example, a moment function I(x,y) can be selected according a regular 2D sharp of hand. Then first-order and second-order moment M₀₀ [symbol] M₁₀ [symbol] M₀₁ [symbol] M₁₁ [symbol] M₂₀ [symbol] M₀₂ are calculated according to the selected moment function. The followings are the exemplary function.

$${M}_{00} = {\sum }_{x} {\sum }_{y} I ( x , y )$$

$${M}_{10} = {\sum }_{x} {\sum }_{y} xI ( x , y )$$

$${M}_{01} = {\sum }_{x} {\sum }_{y} yI ( x , y )$$

$${M}_{11} = {\sum }_{x} {\sum }_{y} xyI ( x , y )$$

$${M}_{20} = {\sum }_{x} {\sum }_{y} {x}^{2} I ( x , y )$$

$${M}_{02} = {\sum }_{x} {\sum }_{y} {y}^{2} I ( x , y )$$

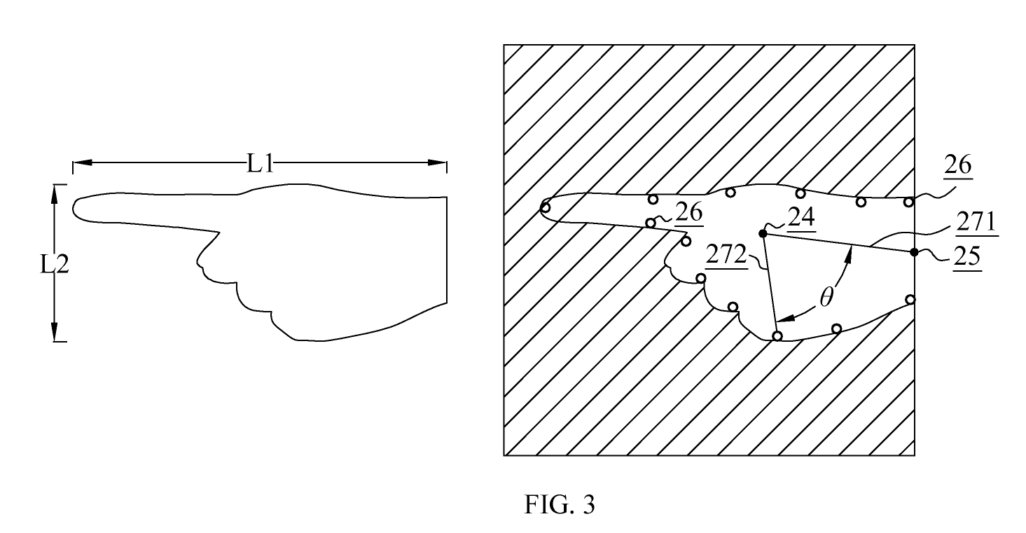

The moment M₀₀ [symbol] M₁₀ [symbol] M₀₁ are calculated according to the following functions, in order to obtain the gravity center. FIG. 3 also shows an exemplary location of gravity center 41.

$${x}_{c} = \frac{{M}_{10}}{{M}_{00}} , {y}_{c} = \frac{{M}_{01}}{{M}_{00}}$$

The length L₁ and width L₂ of equivalent rectangular for hand can be obtained by calculating x_{c} [symbol] y_{c} [symbol] M₀₀ [symbol] M₁₁ [symbol] M₂₀ and M₀₂ according to the following functions.

$$a = \frac{{M}_{20}}{{M}_{00}} - {x}_{c}^{2} , b = 2 ( \frac{{M}_{11}}{{M}_{00}} - {x}_{c} {y}_{c} ) , c = \frac{{M}_{02}}{{M}_{00}} - {y}_{c}^{2}$$

$${L}_{1} = \sqrt{6 ( a + c + \sqrt{{b}^{2} + {( a - c )}^{2}} )}$$

$${L}_{2} = \sqrt{6 ( a + c - \sqrt{{b}^{2} + {( a - c )}^{2}} )}$$

In step 14 contour points on a contour of the contoured hand image are obtained, such as the points 26 which are shown in FIG. 3 and located along with the hand contour 22. In step 15 multiple distances between the gravity center and the multiple contour points are calculated, such as the distance d shown in FIG. 3. In step 16 a hand posture is recognized according to a first characteristic function of the multiple distances. Preferably, the first characteristic function can be a function of multiple distances and included angles formed by the gravity center, a reference point and contour points. In FIG. 3, an included angle θ is formed by a first line 271 connecting with the gravity center and a reference point 25, and a second line 272 connecting with the gravity center and one of contour points 26.

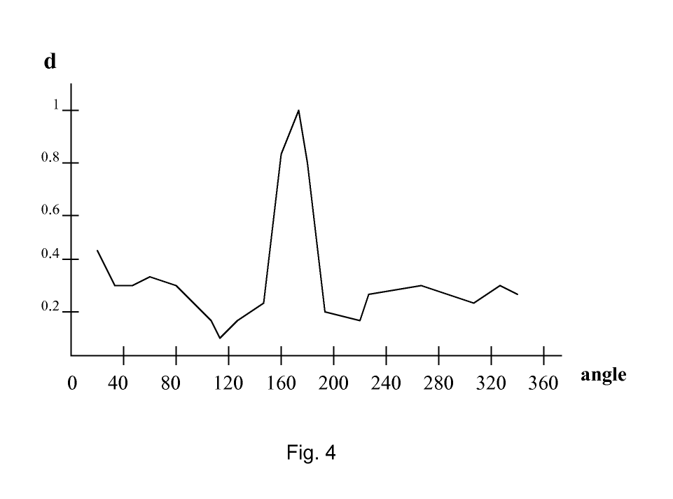

FIG. 4 illustrates a waveform chart of the characteristic function of the distances and included angles corresponding to contour points in accordance with the present invention, where the horizontal axis is set as the included angle and the vertical axis is set as the distance. Preferably, the normalized distance value applied in the waveform can reduce the effect caused by the different contoured hand image size.

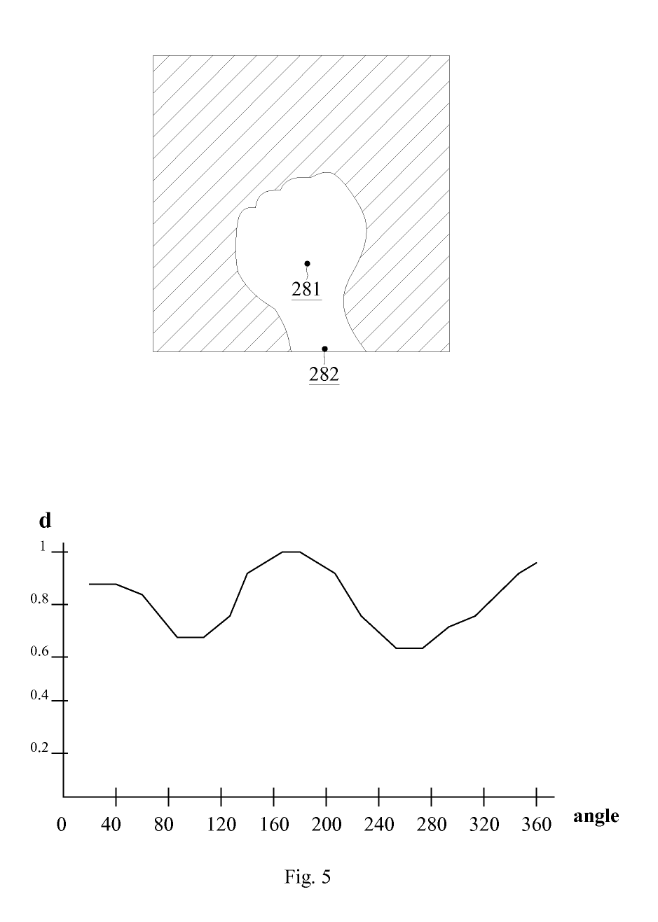

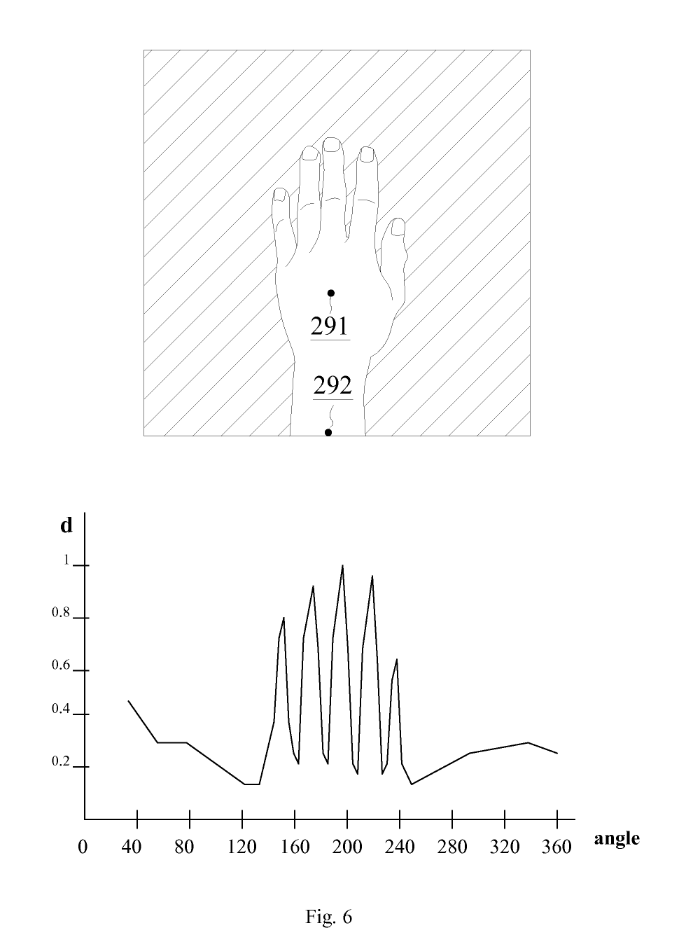

Area of finger is smaller than one of palm, so the gravity center of contoured hand image is usually located at the center area of palm. When user holds a finger posture, distance between the tip of figure and the gravity center is longer than other distances between contour points and the gravity center. Therefore, it is noted that the existence of peak in the waveform can be used to determine whether the contoured hand image is an image of figure posture or not. Preferably, the number of peak can be used to determine the finger number of the posture. In embodiment, an angle range and a distance threshold can be defined for checking existence of peak in the waveform. In the defined angle range, if a local maximum is located and the variance of distance is larger than the distance threshold, it can be determined that a peak exists in the defined angle range, such as waveform charts shown in FIG. 4 and FIG. 6 respectively. Otherwise, if a local maximum is located in the defined angle range but the variance of distance is smaller than the distance threshold, it is determined that no peak exists in the defined angle range, such as waveform charts shown in FIG. 5. According to the defined angle range, the whole waveform can be divided into several portions to check existence of peak.

Preferably, the orientation of the contoured hand image can be determined by position of the reference point in the image and the position of peak in the waveform. For example, if the reference point is located in the right edge of image and the peak exist at the range between 140 degrees and 220 degrees, it can be determined that the orientation of posture is toward west direction. In waveform shown in FIG. 4, one peak exists and its angle location is between 150 degrees and 200 degrees, and the reference point is located at the right edge of image, so that it can be determined that the contoured hand image is a one-figure posture toward west direction. In FIG. 5, the waveform is obtained based on the gravity center 281 and defined reference point 282. The contoured hand image is determined as a clenched fist posture because no peak exists in waveform. In FIG. 6, the waveform is obtained based on the gravity center 291 and defined reference point 292, and five peaks exist in the waveform and their angle locations are between 150 degrees and 250 degrees, and the reference point 292 is located at the bottom edge of image, so that it can be determined that the contoured hand image is a five-figure posture toward north direction.

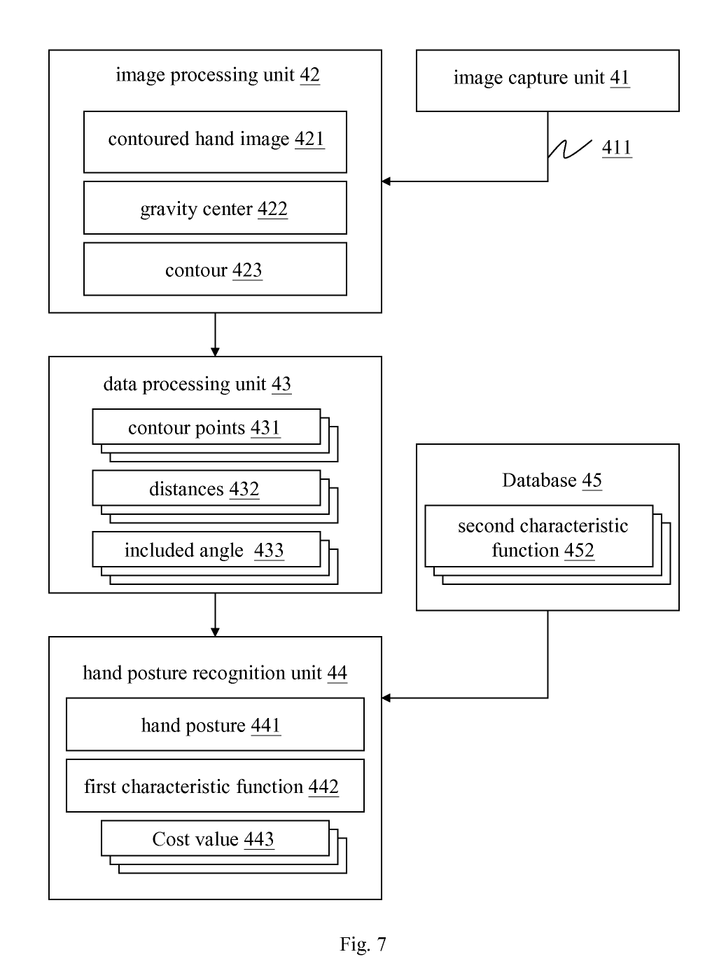

FIG. 7 illustrates a block diagram of embodiment of a vision based hand posture recognition system in accordance with the present invention. This embodiment comprises an image capture unit 41, an image processing unit 42, a data processing unit 43, a hand posture recognition unit 44 and a database 45. The image capture unit 41 is operable to receive an image frame 411, and the image processing unit 42 then extracts a contoured hand image 421 from the image frame 411 and calculates a gravity center 422 of the contoured hand image 421. The data processing unit 43 is operable to obtain contour points 431 on a contour 423 of said contoured hand image 421, and calculating distances 432 between the gravity center 422 and the multiple contour points 431. Preferably, the image capture unit 41 can be a camera or webcam. Preferably, the data processing unit 43 can further calculating included angles 433 formed by the gravity center 422, a reference point and contour points 431, such as angles θ shown in FIG. 3.

The hand posture recognition unit 44 is operable to recognize a hand posture 441 according to a first characteristic function 442 of the multiple distances 432. The database 45 records second characteristic functions of multiple predefined hand postures. Preferably, the hand posture recognition unit 44 can calculate cost values 443 between first characteristic function 442 and multiple second characteristic functions 452 and select one of multiple predefined hand postures as hand posture 441 according to cost values 443. For example, both first characteristic function 442 and second characteristic function 452 can be function of multiple distances 432 and included angles 433, which can be illustrated as a waveform shown in FIG. 4, FIG. 5 or FIG. 6. The hand posture recognition unit 44 can calculate the difference between waveforms of first characteristic function 442 and one of each second characteristic function 452, and the difference is defined as cost values 443, so that the hand posture recognition unit 44 selects the predefined hand posture corresponding to the second characteristic function 452 having smallest difference from first characteristic function 442, as hand posture 441.

Preferably, the hand posture recognition unit 44 can recognize a hand posture 441 corresponding to contoured hand image 421, according to peak number and peak location of waveform corresponding first characteristic function 442. For example, the existence of peak in the waveform can be used to determine whether the contoured hand image is an image of figure posture or not, and the number of peak can be used to determine the finger number of the posture, and the orientation of the hand posture 441 can be determined by position of the reference point in the image and peak position in the waveform.

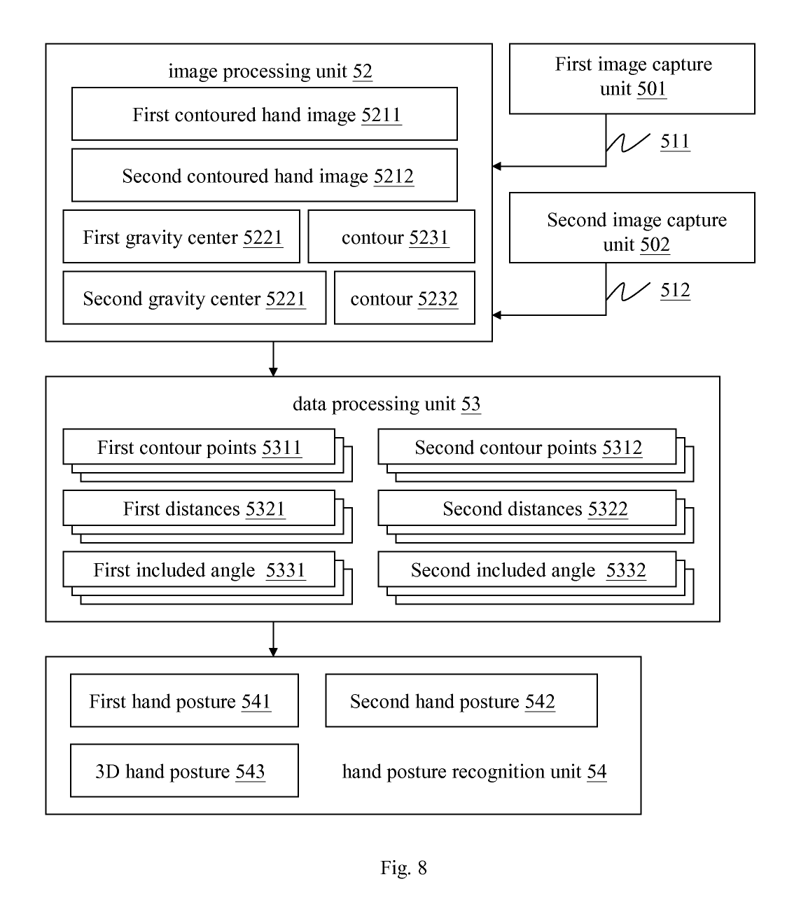

FIG. 8 illustrates a block diagram of embodiment of a 3D hand posture recognition system in accordance with the present invention. In this embodiment, the system comprises a first image capture unit 501, a second image capture unit 502, an image processing unit 52, a data processing unit 53 and a hand posture recognition unit 54. The first image capture unit 501 receives a first image frame 511 and the second image capture unit 502 receives a second image frame 512.

The image processing unit 52 is operable to extract a first contoured hand image 5211 and a second contoured hand image 5212 from the first image frame 511 and the second image frame 512 respectively, and calculate a first gravity center 5221 of the first contoured hand image 5211 and a second gravity center 5222 of the second contoured hand image 5212.

The data processing unit 53 then obtains first contour points 5311 on the contour 5231 of the first contoured hand image 5211, and obtains second contour points 5312 on the contour 5232 of the second contoured hand image 5212, and calculates first distances 5321 between the first gravity center 5221 and the first multiple contour points 5311, and calculates second distances 5322 between the second gravity center 5222 and the second multiple contour points 5312.

The hand posture recognition unit 54 is operable to recognize a first hand posture 541 according to a characteristic function of the multiple first distances, and recognize a second hand posture 542 according to a characteristic function of the multiple second distances, and determine a 3D hand posture 543 according to the first hand posture 541 and the second hand posture 542. Preferably, the hand posture recognition unit 54 can recognize the first hand posture 541 or the second hand posture 542 according to number and location of at least one peak of characteristic function.

The above-described functions or units may be performed by a processor such as a microprocessor, a controller, a microcontroller or an application specific integrated circuit (ASIC) which is coded so as to perform the functions. The design, development and implementation of the code are apparent to those skilled in the art on the basis of the description of the present invention.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A vision based hand posture recognition method, comprising:
receiving an image frame;
extracting a contoured hand image from said image frame;
calculating a gravity center of said contoured hand image;
obtaining contour points on a contour of said contoured hand image;
calculating distances between said gravity center and said multiple contour points; and
recognizing a hand posture according to a first characteristic function of said multiple distances.

2. The vision based hand posture recognition method according to claim 1, wherein the step of recognizing a hand posture further comprises:
setting a reference point;
calculating a first line between said gravity center and said reference point;
calculating second lines between said gravity center and each of said contour points;
calculating angles between said first line and said second lines; and
defining said first characteristic function being a function of said angles and said distances.

3. The vision based hand posture recognition method according to claim 2, wherein the step of recognizing a hand posture further comprises:
providing a database recording second characteristic functions of multiple predefined hand postures;
calculating cost values between said first characteristic function and said second characteristic functions; and
according to said cost values, selecting one of multiple predefined hand postures as said hand posture.

4. The vision based hand posture recognition method according to claim 2, wherein the step of recognizing a hand posture further comprises:
determining whether any peak exists in said first characteristic function; and
if at least one peak exists in said first characteristic function, recognizing said hand posture according to number and location of said peak of said first characteristic function.

5. The vision based hand posture recognition method according to claim 4, further comprising:
if no peak exists in said first characteristic function, determining said hand posture to be a fist posture.

6. The vision based hand posture recognition method according to claim 4, further comprising a step of determining a finger number of said hand posture according to said number of said peak.

7. The vision based hand posture recognition method according to claim 4, further comprising a step of determining a hand direction of said hand posture according to said location of said peak.

8. A vision based hand posture recognition system, comprising:
an image capture unit for receiving an image frame;
an image processing unit for extracting a contoured hand image from said image frame and calculating a gravity center of said contoured hand image;
a data processing unit for obtaining contour points on a contour of said contoured hand image, and calculating distances between said gravity center and said multiple contour points; and
a hand posture recognition unit for recognizing a hand posture according to a first characteristic function of said multiple distances.

9. The vision based hand posture recognition system according to claim 8, wherein said data processing unit further calculates angles between a first line and multiple second lines, and defines said first characteristic function being a function of said angles and said distances, wherein said first line is connected with said gravity center and a reference point, and each of said second lines is connected with said gravity center and each of said contour points.

10. The vision based hand posture recognition system according to claim 9, further comprising a database recording second characteristic functions of multiple predefined hand postures, wherein said hand posture recognition unit further calculates cost values between said first characteristic function and said second characteristic functions, and selects one of multiple predefined hand postures as said hand posture according to said cost values.

11. The vision based hand posture recognition system according to claim 9, wherein said hand posture recognition unit further determines at least one peak of said first characteristic function, and recognizes said hand posture according to number and location of said peak of said first characteristic function.

12. The vision based hand posture recognition system according to claim 11, wherein said hand posture recognition unit determines said hand posture to be a fist posture if no peak exists in said first characteristic function.

13. The vision based hand posture recognition system according to claim 11, wherein said hand posture recognition unit determines a finger number of said hand posture according to said number of said peak, and determines a hand direction of said hand posture according to said location of said peak.

14. A 3D hand posture recognition system, comprising:
a first image capture unit for receiving a first image frame;
a second image capture unit, for receiving a second image frame;
an image processing unit for extracting a first contoured hand image and a second contoured hand image from said first image frame and said second image frame respectively, and calculating a first gravity center of said first contoured hand image and a second gravity center of said second contoured hand image;
a data processing unit for obtaining first contour points on the contour of said first contoured hand image, and obtaining second contour points on the contour of said second contoured hand image, and calculating first distances between said first gravity center and said first multiple contour points, and calculating second distances between said second gravity center and said second multiple contour points; and
a hand posture recognition unit for recognizing a first hand posture according to a first characteristic function of said multiple first distances, and recognizing a second hand posture according to a second characteristic function of said multiple second distances, and determining a 3D hand posture according to said first hand posture and said second hand posture.

15. The 3D hand posture recognition system according to claim 14, wherein said hand posture recognition unit recognizes said first hand posture according to number and location of at least one peak of said first characteristic function, and recognizes said second hand posture according to number and location of at least one peak of said second characteristic function.
